(19) United States
(12) Patent Application Publication
(10) Pub. No.: US 2023/0092392 A1
(43) Pub. Date: Mar. 23, 2023

(54) THERAPEUTIC ENVIRONMENT SENSING AND/OR ALTERING DEVICE

(71) Applicant: Solaria Systems, Inc., Millbrook, NY (US)

(72) Inventors: Sofia Axelrod, Millbrook, NY (US); Grant Kenji Larsen, Millbrook, NY (US)

(21) Appl. No.: 17/949,094

(22) Filed: Sep. 20, 2022

Related U.S. Application Data
(60) Provisional application No. 63/246,661, filed on Sep. 21, 2021.
(60) Provisional application No. 63/250,822, filed on Sep. 30, 2021.

(51) Int. Cl. F21V 3/04; F21V 23/04; F21V 9/00; F21V 33/00

(52) U.S. Cl. CPC F21V 3/04; F21V 23/0485; F21V 9/00; F21V 33/0056

(57) ABSTRACT

An edge device is provided for use in a therapeutic lighting, sensing, and software system may aid users in various ways. The edge device may include a lamp surrounded by a housing. The housing may include a capacitive touch plate for receiving touch commands from a user. The housing may include one or more internal reflectors and one or more optical diffusers configured to limit light emissions from the edge device, such that only light having a wavelength of greater than 620 nm is emitted. The housing may include a capacitive touchpad configured to dampen sound from a user activation of the touchpad.

### RELATED APPLICATIONS

Under provisions of 35 U.S.C. § 119(e), the Applicant claims benefit of U.S. Provisional Application No. 63/246,661 filed on Sep. 21, 2021 and U.S. Provisional Application No. 63/250,822 filed on Sep. 30, 2021, and having inventors in common, which are incorporated herein by reference in its entirety.

It is intended that the referenced applications may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to therapeutic light emitting device, and particularly to environment sensing and/or altering devices for use with a digital health platform.

### BACKGROUND

When caring for another person, turning on a light may allow a caregiver to inspect and assess needs of the other person more accurately, but runs a risk of awakening the other person, by the light and/or because of the sound when turning the light on. Alternatively, if the caregiver does not turn on the light, the other person is less likely to wake up, but the caregiver is less able to inspect and assess the other person in the darkness.

Additionally, certain wavelengths of light are more likely to cause a wakeful response to those exposed to them. Many physiological parameters including body temperature, blood pressure, liver function, muscle strength, mood, alertness, and many hormones, including the sleep hormone melatonin, exhibit daily oscillations with a periodicity of about a day (Latin: ‘circa′=about, ‘diem′=a day). Circadian rhythms are “entrained” by so-called zeitgebers to a particular phase to promote alignment of the inner clock with the outside world. The main zeitgeber is ˜480 nm blue light. Exposure to this wavelength, which is present in daylight as well as most electrical lighting, triggers activation of the light receptor melanopsin in the ipRGCs, a special non-vision-forming cell type in the retina. The light signal is transmitted from the eyes to the suprachiasmatic nucleus, a dedicated brain area which regulates most circadian processes in the body and is therefore considered the body's “master clock.”

Certain wavelengths of light (e.g., wavelengths near 480 nm) can disrupt the circadian clock, suppresses the sleep hormone melatonin, and is therefore a powerful modulator of our sleep/wake cycles. After sunset, melatonin can rise, and sleep is promoted. Research shows that electrical lighting in our homes and light emitted from screens including e-readers and smartphones is highly effective in disrupting circadian rhythms, suppressing melatonin production in the evening, and causing sleep loss in both adults and children, creating a link between the high prevalence of insomnia and electrical lighting. On the other hand, indoor lighting is typically not strong enough to elicit the positive physiological effects of light during the day.

Given light's therapeutic properties, including impact on circadian rhythms, light interventions have been studied as a tool to improve sleep and increase human health and well-being. Bright light therapy for insomnia as well as other health conditions including depression has been proven effective in clinical trials, and the effect of circadian lighting-increasing the aspect of 480 nm-enriched (melanopic) light during the day and decreasing melanopic light exposure in the evening and during the night—has been shown to help office and shift workers, travelers, students and adolescents, NICU babies, nursing home residents, Alzheimer patients, cancer patients and new mothers to improve sleep, reduce inflammation, improve alertness, memory, cognition and mood, reduce jetlag, feel better and be more productive reduce fatigue, and enhance effectiveness of some pharmacological substances.

While circadian lighting has a number of health benefits, it is not readily available for the general public. Accordingly, there is a need for a circadian lighting solution that is gentle enough to not awaken a sleeping person or to alter the circadian rhythms of the caregiver, and that is quiet enough to not disrupt a sleeping person when turned on or otherwise actuated. There is additional need for active circadian devices in therapeutic, clinical, and/or hospital settings.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

One type of an environment sensing and/or altering device, also known as a sleep lamp, may be a self-contained device that emits light in a spectrum designed not to impact a sleep cycle of those exposed to the light. In some embodiments, the sleep lamp may optionally be included as a part of a distributed system, such as a therapeutic lighting and digital health system, as an edge device. The sleep lamp may be used at least for emitting light and/or sound to alter an environment within a room, and/or for sensing environmental conditions (e.g., light, sound, temperature, humidity, etc.) in a room.

In some embodiments, the sleep lamp may be a capacitive touch lamp. The sleep lamp may initially be in an “off” state (e.g., unpowered), and an activation may advance an illumination of the lamp to a dim setting. One or more subsequent activations of the sleep lamp may increase the brightness. Further activation of the sleep lamp may return the lamp to the off state.

In some embodiments, the sleep lamp may optionally include an audio pickup or sensor. The audio sensor may be used to identify noises associated with wakefulness in a room. For example, the sensor may determine that a baby is crying in the room. In some embodiments, the determination may include local and/or remote machine learning processes for identifying and categorizing sounds as either sounds indicating wakefulness (e.g., crying, talking etc.) or sounds indicating sleep (e.g., snoring). In embodiments, the audio sensor may use an audio level threshold determination. Detection of the sound threshold or classified sounds indicating wakefulness may be used to trigger automatic dim illumination. This may allow a parent or other caretaker to audit the room without even being close to the lamp.

In some embodiments, the sleep lamp may include a noise generator for emitting sounds (e.g., a white noise generator or other audio generator such as gentle tones, rain sounds, etc.). The noise generator may optionally be configured to automatically activate upon detection of the sound threshold or classified sounds indicating wakefulness. The automatic activation of light and/or audio output in response to the audio input trigger may enhance the use of the lamp and as illumination and safety device by the parent or caretaker. A volume of the noise generator may be controlled via activation of the sleep lamp, in a manner similar to control of the lamp (e.g., with soft->medium->loud->off controls). In embodiments, the noise generator and the lamp may be controlled independently. The sleep lamp may detect activation patterns and may interpret the detected patterns as signals, allowing patterns to be more complex than a single touch or activation, and allowing more controls.

In another embodiment the sleep lamp may communicate at least a portion of (e.g., all) detection and control events to a digital health platform, such as a circadian data platform. The platform may analyze behavior based on the received data, including changes or improvement in sleep pattern reinforcement, and parent or caretaker control behavior for sleep training purposes. Data trends such as time of day and length of sleep may be transmitted and analyzed for augmented lamp usage. Sleep lamp responses (e.g., altering audio volume or light level) may be initiated automatically to help soothe a user (e.g., a baby) back to restful sleep when the user begins to stir at undesired times.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a sleep lamp for use in as part of a therapeutic lighting system, consistent with the present disclosure;

FIG. 2A is a schematic diagram illustrating electrical components of a first sleep lamp consistent with the present disclosure;

FIG. 2B is a schematic diagram illustrating electrical components of a second sleep lamp consistent with the present disclosure;

FIG. 3 illustrates internal structural components of a sleep lamp consistent with the present disclosure; and

FIG. 4 is a block diagram of a system including a computing device that may be a part of a sleep lamp consistent with the present disclosure.

### DETAILED DESCRIPTION

The present disclosure can be understood more readily by reference to the following detailed description of the disclosure and the Examples included therein.

Before the present articles, systems, devices, and/or methods are disclosed and described, it is to be understood that they are not limited to specific manufacturing methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present disclosure, example methods and materials are now described.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including matters of logic with respect to arrangement of steps or operational flow; plain meaning derived from grammatical organization or punctuation; and the number or type of aspects described in the specification.

Any and all publications mentioned herein are incorporated herein by reference to disclose and describe the methods and/or materials in connection with which the publications are cited.

### Definitions

It is also to be understood that the terminology used herein is for the purpose of describing particular aspects only and is not intended to be limiting. As used in the specification and in the claims, the term “comprising” can include the aspects “consisting of” and “consisting essentially of” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “an assembly” includes two or more assemblies.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Disclosed are the components to be used to manufacture the disclosed devices and articles of the disclosure as well as the materials themselves to be used within the methods disclosed herein. These and other materials are disclosed herein, and it is understood that when combinations, subsets, interactions, groups, etc. of these materials are disclosed that while specific reference of each various individual and collective combinations and permutation of these materials cannot be explicitly disclosed, each is specifically contemplated and described herein. For example, if a particular material is disclosed and discussed and a number of modifications that can be made to the materials are discussed, specifically contemplated is each and every combination and permutation of the material and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the articles and devices of the disclosure. Thus, if there are a variety of additional steps that can be performed it is understood that each of these additional steps can be performed with any specific aspect or combination of aspects of the methods of the disclosure.

It is understood that the devices and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

### I. Overview

This overview is provided to introduce a selection of concepts in a simplified form that are further described below. This overview is not intended to identify key features or essential features of the claimed subject matter. Nor is this overview intended to be used to limit the claimed subject matter's scope.

A sleep lamp may be used independently or, optionally, as part of a therapeutic lighting, sensing, and software system. In some embodiments, the sleep lamp may include one or more sensors for gathering information about conditions in the area surrounding the sleep lamp, and/or for gathering information regarding one or more touches of a designated area of the lamp. In some embodiments, the sleep lamp may communicate with a digital health platform including a backend computing device. For example, the sleep lamp may provide data gathered from the one or more sensors to the backend computing device. In some embodiments, the sleep lamp may optionally receive one or more commands from the backend computing system to control the lamp. Additionally or alternatively, the sleep lamp may include a processor for analysis of the data gathered by the one or more sensors.

The sleep lamp may be a device used to administer therapeutic light to a user, such as light in a spectrum designed not to reset the circadian rhythms of the user. In some embodiments, the sleep lamp may also be used for additional purposes, such as generating sounds for a user, sensing ambient light conditions in the vicinity of a user, sensing noise conditions in the vicinity of the user, and receiving commands from a user.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. System Configuration

One possible embodiment of the present disclosure provides a software and hardware platform comprised of a set of components. For example, the components may be divided into a set of structural components, and a set of electrical components. The components may include, but are not limited to:

### A. Housing

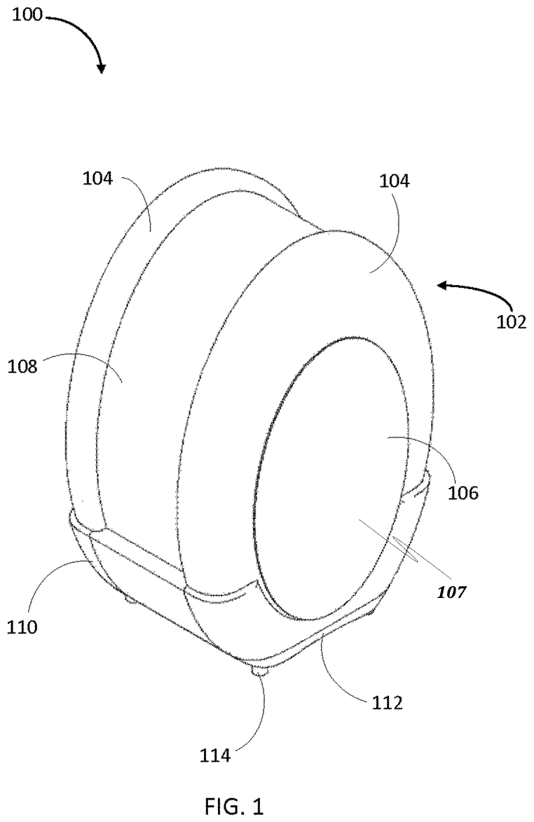

FIG. 1 illustrates a perspective view of a sleep lamp 100 (e.g., a therapeutic light emitting device) consistent with an embodiment of the disclosure. As shown in FIG. 1, the sleep lamp 100 includes a housing 102 that substantially encloses the lamp. In embodiments, the housing 102 may include frame members 104, one or more leaf members 106, a diffuser 108, a cup support member 110, a base 112, and a set of feet 114. The housing 102 may be formed from durable materials, such as wood, metal, and/or various plastics. In some embodiments, the housing is preferably formed from a sound dampening material or a material designed not to emit sound when contacted (e.g., by a user). In particular, wood and plastic may provide sound dampening characteristics in addition to their durability. In some embodiments, various portions of the housing may be formed from and/or may include different materials. Alternatively, all portions of the housing may be formed from or include the same material. As a particular example, all members of the housing may be formed from or may include wood.

The housing 102 may include one or more frame members 104. As shown in FIG. 1, the housing 102 may include a pair of frame members 104. The one or more frame members 104 may generally describe a shape of the sleep lamp 100. For example, as shown in FIG. 1, the frame members 104 describe a generally oval shape, and the sleep lamp 100 is shaped as an oval prism. In some embodiments, each frame member 104 may define a side of the sleep lamp 100, and may make up of a body volume of the sleep lamp.

The housing 102 may include one or more leaf members 106. In embodiments, each leaf member 106 may have a shape relatively similar to that of the frame members 104. In some embodiments, each leaf member 106 may be formed from a non-conductive material, such as wood or plastic. The leaf member 106 may be designed to help minimize noise created by actuation of the lamp 100 by a user. In some embodiments, the leaf member 106 is formed from a sound dampening material or a material designed not to emit sound when contacted (e.g., by a user). The non-conductive material may have a capacitive electrode 107 embedded therein. The conducting portion of the capacitive electrode 107 may be formed from a conductive material (e.g., a metal such as copper, aluminum, or silver; a conductive ceramic such as Titanium Dichloride; other conductive materials such as Indium Tin Oxide; etc.). Various conductive materials may be used to form the capacitive electrode 107. In embodiments, the capacitive electrode 107 may be formed as an embedded disc, an embedded mesh, or any other shape useful for allowing conduction through the non-conductive leaf member 106.

In some embodiments, the capacitive electrode 107 may be formed by depositing the conductive material on a polymer thread, such as a nylon thread. Such deposition may be achieved by Chemical Vapor Deposition (CVD) and/or similar deposition processes. The polymer thread having the conductive material deposited thereon may be woven into a conductive cloth.

In other embodiments, the capacitive electrode 107 may be formed as a metal covering, such as a woven metal wire, metal screen, or perforated metal foil. Metal structures such as these are useful, but may have drawbacks. In particular, the metal covering may be relatively thick and heavy when compared to the conductive cloth, and may not adhere well to the leaf member 106 due to its non-porous nature. Additionally, the metal covering may not create a high enough projected surface area to be able to act as a good capacitive touch electrode 107.

To form the leaf member 106, the capacitive electrode 107 may be formed or cut to a size that is slightly smaller than the overall size of the leaf member. The capacitive electrode 107 may be glued, adhered, or otherwise positioned between two layers of the non-conductive material to form the leaf member 106. The outer layer of the non-conductive material may be relatively thin, while the inner layer of the non-conductive material may be relatively thick. In the case of the sleep lamp 100, the relatively thin outer layer allows the leaf member 106 to be used as a capacitive touch plate, and the relatively thick inner layer may provide for mechanical mounting and structural stability. However, in some embodiments where structural stability is of less concern, the inner layer may also be formed from, in whole or in part, from a relatively thin layer, allowing for use as a capacitive touch plate from either side.

When forming the leaf member 106, the capacitive electrode 107 is positioned between the two layers of non-conducting material, becoming encased. In some embodiments, the capacitive electrode 107 is sized smaller than the non-conducting material layers, allowing an outer margin of the leaf member 106 to be a pure joint of the non-conducting material, which is virtually invisible once finished. In an alternate embodiment, the capacitive electrode 107 may be larger than the non-conductive layers, allowing the conductive material to overhang the edges of the non-conductive layers. The conductive material may be trimmed flush with the edges of the non-conductive layers after adhesion is complete.

The non-conductive material may be any material that does not conduct electricity, such as wood, plastic, ceramic, or other non-conductive materials. In particular, the non-conductive material is preferably a sound dampening material or a material designed not to emit sound when contacted (e.g., by a user). In particular, wood and plastic may provide sound dampening characteristics in addition to their non-conductive properties. A thickness of the outer non-conductive layer of the leaf member 106 may be set such that the non-conductive touch layer is thin enough to provide capacitive coupling between the conductive layer (e.g., the capacitive electrode 107) and a human body in physical contact with the outer layer.

An adhesive may be used to glue the thin, outer non-conductive layer to the inner non-conductive layer. In some embodiments, the adhesive may be used to adhere the outer layer to the inner layer through the porous fabric, cloth, mesh, foil, or metalized plastic sheet (such as, but not limited to, aluminized mylar). In addition to the conductive layer, one or more conductive connection parts may be disposed between the non-conductive layers. The conductive connection parts may include, for example, wire, metal coated thread, conductive fabric, conductive epoxy traces, metal pins, metal plates, Indium-Tin-Oxide coated plastic parts, or any other mechanism to contact the conductive electrode layer and/or to bring the connection points to a more mechanically stable portion of the electrode, for connection to an electronic device, such as a capacitive touch controller or microcontroller, discussed in greater detail below.

In some embodiments, The entire sandwich of materials that make up the leaf member 106 may be glued together under compression. Gluing the assembly under compression may help to promote homogeneous flow of the adhesive to more completely adhere the porous fabric to the non-conducting layers. Alternatively or additionally, the compression may help to deflect the wood around thicker areas, such as the contact points, where the thickness of the entrapped objects may be greater than the thickness at areas where only the fabric is present.

In embodiments, there may be multiple contacts within each leaf member 106, in order to allow for robustness if some contacts fail to produce low enough electrical resistance. Additionally, multiple contact points allow for the electrical testing between all combinations of points, allowing for a mapping of resistances across those distances, which may serve as a quality control measure.

The specific combination of a thin dielectric or non-conductive layer (e.g., wood veneer), a porous fabric of high density but thin overall thickness, an adhesive (e.g., wood glue), and a process to glue under compression, allows for a reliable capacitive electrode 107 encased in a non-conductive material, which may be an aesthetic and organic material such as wood. Other materials such as paper, fiberglass, plastic, and even other fabrics may be used in this method.

The housing 102 may include a diffuser 108. The diffuser 108 may be a thin layer that allows light to escape the lamp 100. The diffuser 108 may be retained by the frame members 104. In embodiments, the diffuser 108 may be formed from a thin material that allows at least some light to pass through (e.g., a translucent or transparent material). In some embodiments, the diffuser 108 may be formed from a wood veneer material that allows light to pass through the veneer. The diffuser 108 may optionally include one or more backing layers. Each backing layer may provide added structural support and/or additional optical properties. The diffuser 108 may optionally include one or more splines to support the diffuser.

The diffuser 108 may have various optical properties. In some embodiments, the diffuser 108 may serve as a filter, helping to limit light escaping from the sleep lamp 100. For example, the diffuser 108 may help to prevent light having certain wavelengths from being emitted by the sleep lamp. As a particular example, the diffuser 108 may help to prevent light having a wavelength in the range of about 480-490 nm from being emitted by the sleep lamp. As another particular example, the diffuser 108 may help to prevent all light from being emitted by the sleep lamp, with the exception of light having wavelengths in the range of 620-650 nm or greater (e.g., all light having a wavelength greater than 620 nm). Light having these wavelengths does not promote wakefulness during normal sleep time, but provides sufficient illumination to see the area surrounding the sleep lamp 100.

In some embodiments, the light created (e.g., emitted) by the sleep lamp 100 may be uncollimated light as an illumination device. Accordingly, the diffuser may be illuminated in a substantially even manner. Alternatively, the sleep lamp 100 may emit collimated light (e.g., using one or more lasers and/or focused light emitting diodes). In cases where the sleep lamp produces collimated light, the diffuser 108 may be illuminated by the collimated light to create vector images in the diffuser, or take a projected, focused pixel array to act as a screen for producing an image.

In some embodiments, the diffuser 108 may optionally be used as a sound amplifying surface (e.g., a speaker) in addition to a light diffuser. In particular, a small piezoelectric transducer may be attached to the diffuser 108. When driven with an audio signal, the vibration of the piezoelectric transducer causes the diffuser 108 to vibrate. The diffuser 108 may vibrate along its length, amplifying the audio signal from the piezoelectric transducer. Unlike a conventional speaker cone, which is designed to project sound primarily in one direction, with expanding scope, the diffuser 108 may project sound outward in directions normal to the flat surface of the diffuser and in a directional manner, such that volume of the audio signal is considerably lower in the side-ward directions than in directions substantially normal to at least a portion of the diffuser 108.

The housing 102 may include a cup support member 110. The cup support member may provide a support for the frame members 104. The cup support member 110 may be formed such that the sleep lamp 100 remains stable when a user interacts with (e.g., touches) the lamp. The cup support member 110 is preferably formed from a material similar to that used to form the frame members 104.

The housing 102 may include a base 112. In embodiments, the base 112 may be configured to receive one on more cables (e.g., one or more power cables for providing power to the sleep lamp 100, one or more data transfer cables, etc.). The housing 102 may include a set of feet 114 that protrude from the base 112 to contact a surface on which the sleep lamp rests. The feet 114 may be rubberized to help prevent the sleep lamp from sliding on the surface when interacted with (e.g., touched) by the user, and to help absorb shock in response to a user interacting with (e.g., touching) the lamp 100, thereby damping sound produced by the sleep lamp or interaction therewith by the user. The feet 114 may be designed to help damp vibrations and/or minimize noise created by actuation of the lamp 100 by a user.

### B. Electrical Components

In embodiments, a sleep lamp may include electrical components for operation. In a first form, the sleep lamp may serve as a light emitting device, providing illumination that does not activate the melanopic response in users. In a secondary, more complex form, the sleep lamp may include some advanced features, beyond those included in the first form, as described below.

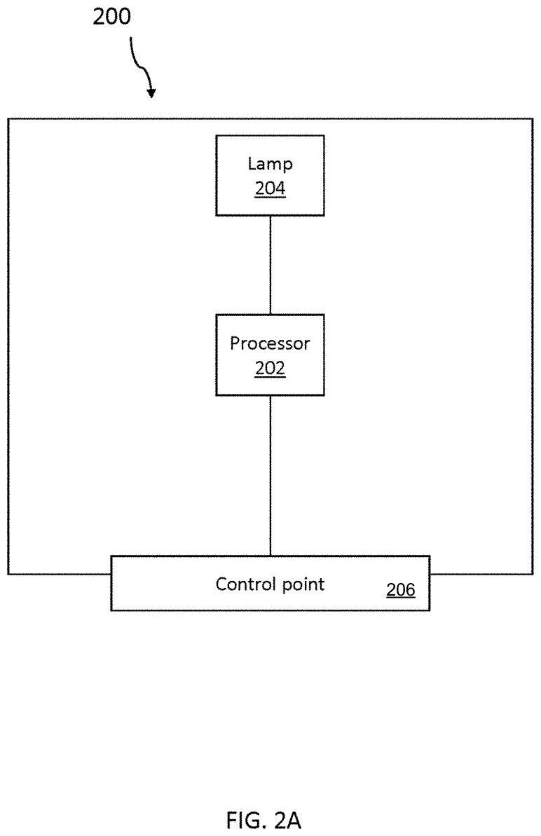

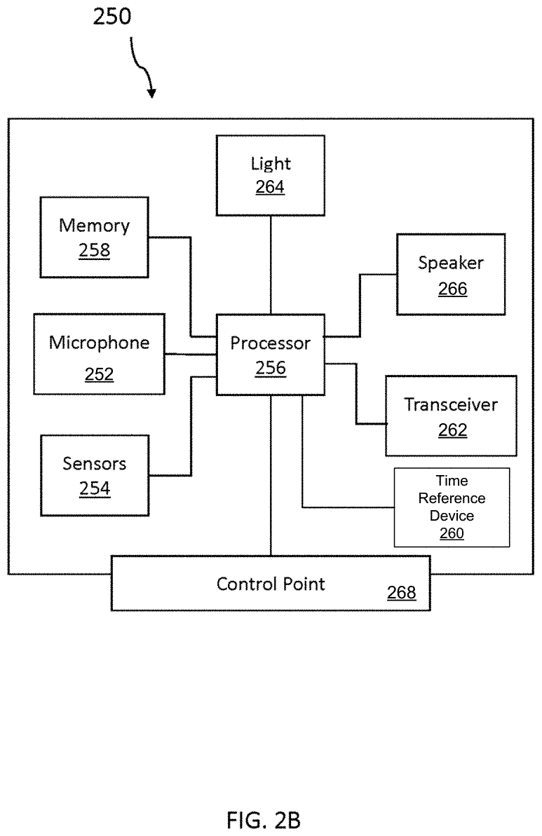

FIG. 2A illustrates a schematic view of first sleep lamp configuration 200. The sleep lamp 200 may include a control module 202, a lamp 204, and a control point 206. In embodiments, the control module 202 and the lamp 204 may be connected to one another, and to the control point 206, by electrically conductive wires.

The sleep lamp 200 may include a control module 202. In embodiments, the control module 202 may be electrically connected to the control point 206 (e.g., the leaf members 106 of FIG. 1) on a housing of the edge device. The control module 202 may enable operation of the sleep lamp 200 as a capacitive touch lamp. For example, the control module 202 may initially cause the lamp 204 to be in an “off” or unpowered state. Actuation of the control point 206 may cause the controller 202 to power the lamp 204 in a “dim” operating state; a first subsequent actuation of the capacitive touch control may cause the controller to power the lamp in a “brighter” operating state; and a second subsequent actuation of the capacitive touch control may cause the controller to power the lamp in a “brightest” operating state. Thereafter, a third subsequent actuation of the capacitive touch control may cause the controller 202 to return the lamp 204 to the “off” operating state. In this way, the controller 202 may serve as a brightness control for the lamp 204. While the above description illustrates a controller 202 configured to provide three brightness settings (in addition to an “off” setting), those of skill in the art will recognize that more or fewer brightness settings are possible without departing from the scope of the invention.

The sleep lamp 200 may include a lamp 204. In some embodiments, the lamp 204 may take the form of one or more light emitting diodes, one or more laser emitters, and/or any other source of collimated light. Additionally or alternatively, the lamp 204, may include a base socket for receiving a bulb, such as an incandescent light bulb, fluorescent light bulb, LED light bulb, and/or any other source of uncollimated light. In some embodiments, the lamp 204 may include a standard Edison screw base for receiving a bulb, and a bulb sized to mate with the selected base. As a particular example, the lamp 204 may include a 12-millimeter Edison screw base (e.g., an E12 base) to accept a candelabra bulb such as a C7 incandescent bulb or C35 LED bulb (or any E12 socketed bulb that fits the base). As another particular example, the lamp 204 may include an E26.E27 socket to accept an alternate type of bulb such as a T45 bulb (or any such bulb that fits). Other socket types are possible, with the corresponding bulb type.

FIG. 2B shows a schematic view of second sleep lamp configuration 250. The digital operating edge device 250 may include a microphone 252, one or more sensors 254, a processor 256, a memory 258, a time reference device 260, a transceiver 262, a light 264, and/or an audio amplifier 266. In embodiments the second edge device 250 is an advanced edge device that may be configured to send data to and/or receive data from a centralized server.

The sleep lamp 250 may include a microphone 252. The microphone 252 may be used to receive sound and/or measure sound intensity in the environment surrounding the sleep lamp 250. The microphone 252 may be, for example, a MEMS microphone, a piezoelectric microphone, an electret condenser microphone, or any other transducer capable of converting sound waves to an electrical impulse.

The sleep lamp 250 may include one or more sensors 254 instead of or in addition to the microphone 252. In embodiments, the one or more sensors 254 may collect ambient environmental data relating to the environment surrounding the user. As particular examples, the one or more sensors 254 may include a camera, a temperature sensor, an air pressure sensor, and/or a lux meter (e.g., one or more photodiodes). Various sensors 254 may be used to measure ambient environmental data that may affect user health or behavior.

The second edge device 250 may include a processor 256 connected to the microphone 252 and/or the one or more sensors 254. The processor 256 may be capable of analyzing the data received from the microphone 252 and/or the one or more sensors 254. In some embodiments, the analysis may optionally include using machine learning to analyze the data. That is, the inputs may be provided to a trained machine learning model capable of categorizing the received data. The machine learning model may be stored locally, at the sleep lamp 250, and/or at a server in communication with the sleep lamp. Alternatively or additionally, the analysis may include a threshold analysis and/or an algorithmic analysis instead of or in addition to the machine learning. The processor 256 may produce, as output, a signal for controlling the lamp 264 and/or the audio amplifier 266 based on the processed input signals from the microphone 252 and/or the sensors 254.

As an example, the processor 256 may analyze data from the microphone 252 to determine whether sounds in the room are indicative of sleep (e.g., snoring) or wakeful activities (e.g., talking, crying etc.). As another example, the processor 256 may analyze data from a camera among the sensors 254 to determine if there is movement in the vicinity of the sleep lamp 250. In some embodiments, the processor 256 may produce, as output, a signal for activating the lamp 264 based on the processed input sensor signals to illuminate the area so that a caretaker can see to check on a crying baby. In some embodiments, the processor 256 may produce, as output, a signal for activating the audio amplifier 266 based on the processed input sensor signals to produce soothing sounds in an effort to put a user to sleep.

The second edge device 250 may include a memory 258. The memory 258 may be a random-access memory (RAM) device, such as a flash memory. The memory 258 may be accessible by the microphone 252, the one or more sensors 254, the processor 256, the transceiver 262, and/or any other component of the sleep lamp 250.

The sleep lamp 250 may include a time reference device 260. In some embodiments, the time reference device 260 may include a real time clock (RTC). The time reference device 260 allows the sleep lamp 250 to determine a current time of day and a current date. Based on the date, the sleep lamp may also determine a current season. Determining both time of day and season may be important for circadian rhythms and improving sleep health. In other embodiments (e.g., where no RTC is present), the time reference device 260 may be a remote time source, or may correspond to a user input setting the time and date, wherein the processor 256 may serve as the time reference device 260 by counting clock cycles. In embodiments, the time reference device 260 may serve as an input to the processor 256 for use in calculating one or more output signals.

The sleep lamp 250 may include a transceiver 262 for communication with other devices. The transceiver 262 may be configured to send and receive signals. The signals may include wireless signals, such as radio frequency (RF) signals (including sub-gigahertz signals) and/or Internet of Things (IoT) radio frequencies (e.g., those set aside for industrial, scientific and medical (ISM) purposes), signals compliant with the International Electrical and Electronics Engineers (IEEE) 802.11 standards, signals compliant with Bluetooth (e.g., IEEE 802.15.1) standards, signals compliant with ZigBee (IEEE 802.15.4) standards, or any other wireless signals useful for communicating data between devices. Additionally or alternatively, the signals may include data communication signal suitable for wired communication (e.g., via IEEE 802.3 communication standards). In embodiments, the transceiver 262 may facilitate transmission of data (e.g., data received from the microphone 252 and/or the one or more sensors 254) to a server. In some embodiments, the transceiver 262 may be in communication with an external time source as part of the time reference device 260.

The second edge device 250 may include a light (or lamp) 264 for illuminating an area surrounding the second edge device. The lamp 264 may comprise one or more light emitting diodes (LEDs), such as one or more surface mounted device (SMD) LEDs. The lamp 264 may emit light having wavelengths of more than 580 nm. For example, the lamp 264 may emit light at least having wavelengths in the range of 620-650 nm, or light having wavelengths greater than 620 nm. Light having these wavelengths does not promote wakefulness during normal sleep time, but provides sufficient illumination to see the area surrounding the second edge device 250. In some embodiments, the lamp 264 may emit light having a broad spectrum of wavelengths (e.g., white light). In some embodiments, the lamp 264 may take the form of one or more light emitting diodes, one or more laser emitters, and/or any other source of collimated light. Additionally or alternatively, the lamp 264, may include a base socket for receiving a bulb, such as an incandescent light bulb, fluorescent light bulb, LED light bulb, and/or any other source of uncollimated light. In some embodiments, the lamp 264 may include a standard Edison screw base for receiving a bulb, and a bulb sized to mate with the selected base. As a particular example, the lamp 264 may include a 12-millimeter Edison screw base (e.g., an E12 base) to accept a candelabra bulb such as a C7 incandescent bulb or C35 LED bulb (or any E12 socketed bulb that fits the base). As another particular example, the lamp 264 may include an E26.E27 socket to accept an alternate type of bulb such as a T45 bulb (or any such bulb that fits). Other socket types are possible, with the corresponding bulb type.

In some embodiments, the sleep lamp 250 may include an audio amplifier 266. The audio amplifier 266 may be controlled by the processor 256 to operate as a noise machine For example, the sleep lamp 250 may use the audio amplifier 266 to emit white noise, pink noise, or the like. In some embodiments, the speaker may be used to output music or other soothing sounds, such as a lullaby, nature sounds, and/or any other soothing sounds. In some embodiments, the audio amplifier 266 may be a speaker. In other embodiments, the audio amplifier 266 may include a piezoelectric transducer connected to a membrane portion of the housing (e.g., the diffuser 108, as shown in FIG. 1).

When driven with an audio signal, the vibration of the piezoelectric transducer element may cause the membrane to vibrate. The entire membrane is free to vibrate along its length. Unlike a speaker cone, which is designed to project sound primarily in one direction, with expanding scope, the diffuser may be able to project sounds outward in directions normal to the flat surface of the membrane. Volume may be considerably lower in the side-ward directions relative to the membrane, when compared to direction that are substantially normal to at least a portion of the membrane. This allows for a more directional experience.

The sleep lamp 250 may include a control point 268 (e.g., the leaf members 106 of FIG. 1) on a housing of the lamp. The control point 268 may be connected to at least the processor 256 to enable operation of the sleep lamp 250 as a capacitive touch lamp. For example, the processor 256 may initially cause the lamp 266 to be in an “off” or unpowered state. Actuation of the control point 268 (e.g., by a user touching the control point) may cause the processor 256 to power the lamp 266 in a “dim” operating state; a first subsequent actuation of the control point may cause the processor to power the lamp in a “brighter” operating state; and a second subsequent actuation of the control point may cause the processor to power the lamp in a “brightest” operating state. Thereafter, a third subsequent actuation of the control point 268 may cause the processor 256 to return the lamp 266 to the “off” operating state. In this way, the processor 256 may serve as a brightness control for the lamp 266. While the above description illustrates a processor 256 configured to provide three brightness settings (in addition to an “off” setting), those of skill in the art will recognize that more or fewer brightness settings are possible without departing from the scope of the invention. Similarly, the control point 268 may also be used to activate, deactivate, and/or control a volume of the audio amplifier 266.

### C. Internal Structural Components

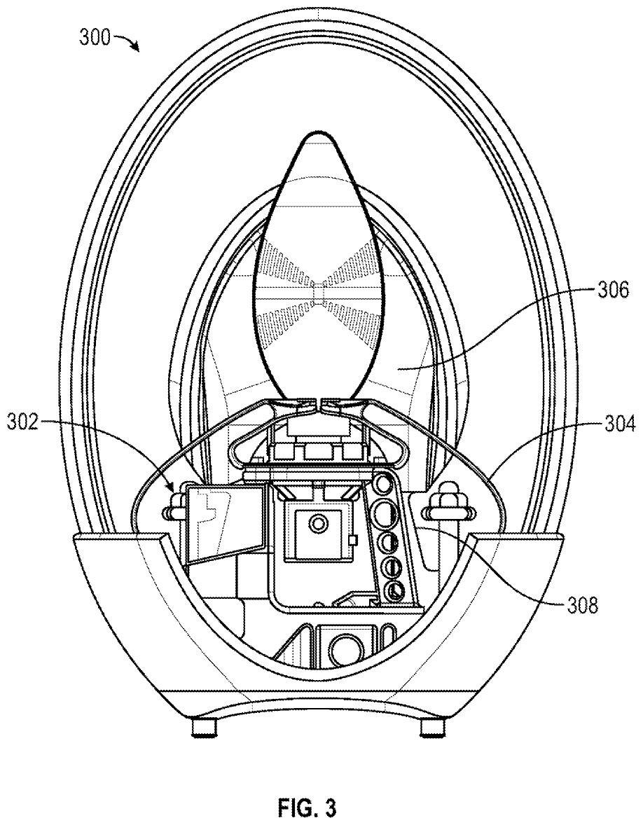

FIG. 3 illustrates an internal structure of an sleep lamp 300 consistent with an embodiment of the disclosure. The internal structure may include a support member 302, one or more lower reflectors 304, one or more side reflectors 306, and one or more weight brackets 308.

The sleep lamp 300 may include a support member 302. The support member 302 may be structure for holding one or more electrical and/or electronic parts of the sleep lamp 300 in a correct position. In embodiments, the position may be determined at least in part by optical considerations for positioning a lamp within a housing of the edge device 300. The support member 302 may be formed from a durable and structurally stable material, such as plastic, wood, or a non-conductive metal. The support member 302 may be securely mounted to a base of the housing.

The sleep lamp 300 may include one or more lower reflectors 304. The lower reflectors 304 may include a set of surfaces for the purpose of directing light emitted from a lamp to the diffuser and out of the sleep lamp. The lower reflectors 304 may help to block light from entering the base portion of the edge device. In some embodiments, at least one (e.g., each) of the one or more lower reflectors 304 may be a colored reflector, such that the lower reflectors 304 reflect light in a particular range of wavelengths (e.g., light having a wavelength above 590 nm, light having a wavelength above 620 nm, light having wavelengths in the range of about 620-650 nm and above), and absorbs light that having a wavelength outside of the particular range (e.g., less than 620 nm). Alternatively, the lower reflector 304 may be a mirrored surface that reflects substantially all light.

The sleep lamp 300 may include one or more side reflectors 306. The side reflectors 306 may be used to direct side illumination from the lamp upward and outward (e.g., to the diffuser and out of the sleep lamp). In some embodiments, the side reflector 306 may be a colored reflector, such that the side reflector reflects light in a particular range of wavelengths (e.g., light having a wavelength above 590 nm, light having a wavelength above 620 nm light having wavelengths in the range of about 620-650 nm and greater), and absorbs light having a wavelength outside of the particular range (e.g., less than 620 nm). Alternatively, the side reflector 306 may be a mirrored surface that reflects substantially all light.

The sleep lamp 300 may include one or more weight brackets 308. The weight bracket 308 may be a bracket or other member for attaching a first portion of the housing (e.g., the leaf member) to a second portion of the housing (e.g., the frame member). In embodiments, the weight brackets 308 may be relatively heavy. The weight brackets 308 may be positioned relatively low within the cavity of the edge device 300, contributing to lowering a center of gravity of the edge device. This lower center of gravity may help to stabilize the edge device 300 when the device is actuated (e.g., touched) by a user. In some embodiments, the lower center of gravity may help to reduce or eliminate noise from the sleep lamp when a user actuates the lamp through capacitive touch. For example, the weight brackets help to stabilize the device, reducing or eliminating any rocking of the sleep lamp 300 during actuation by the user, which would create noise the could wake a sleeping person in the same room as the sleep lamp.

### III. Computing Device

Embodiments of the present disclosure provide a hardware and software platform operative as an edge device for use with a distributed therapeutic lighting, sensing, and digital health system of modules and computing elements.

The edge device (e.g., the first edge device 200, the second edge device 250) may be embodied as, for example, but not be limited to, a website, a web application, a desktop application, backend application, and a mobile application compatible with a computing device 400. The computing device 400 may comprise, but not be limited to the following:

Mobile computing device, such as, but is not limited to, a laptop, a tablet, a smartphone, a drone, a wearable, an embedded device, a handheld device, an Arduino, an industrial device, or a remotely operable recording device;

A supercomputer, an exa-scale supercomputer, a mainframe, or a quantum computer;

A minicomputer, wherein the minicomputer computing device comprises, but is not limited to, an IBM AS400/iSeries/System I, A DEC VAX/PDP, a HP3000, a Honeywell-Bull DPS, a Texas Instruments TI-990, or a Wang Laboratories VS Series;

A microcomputer, wherein the microcomputer computing device comprises, but is not limited to, a server, wherein a server may be rack mounted, a workstation, an industrial device, a raspberry pi, a desktop, or an embedded device;

Embodiments of the present disclosure may comprise a system having a central processing unit (CPU) 420, a bus 430, a memory unit 0, a power supply unit (PSU) 450, and one or more Input/Output (I/O) units. The CPU 420 coupled to the memory unit 0 and the plurality of I/O units 460 via the bus 430, all of which are powered by the PSU 450. It should be understood that, in some embodiments, each disclosed unit may actually be a plurality of such units for the purposes of redundancy, high availability, and/or performance. The combination of the presently disclosed units is configured to perform the stages any method disclosed herein.

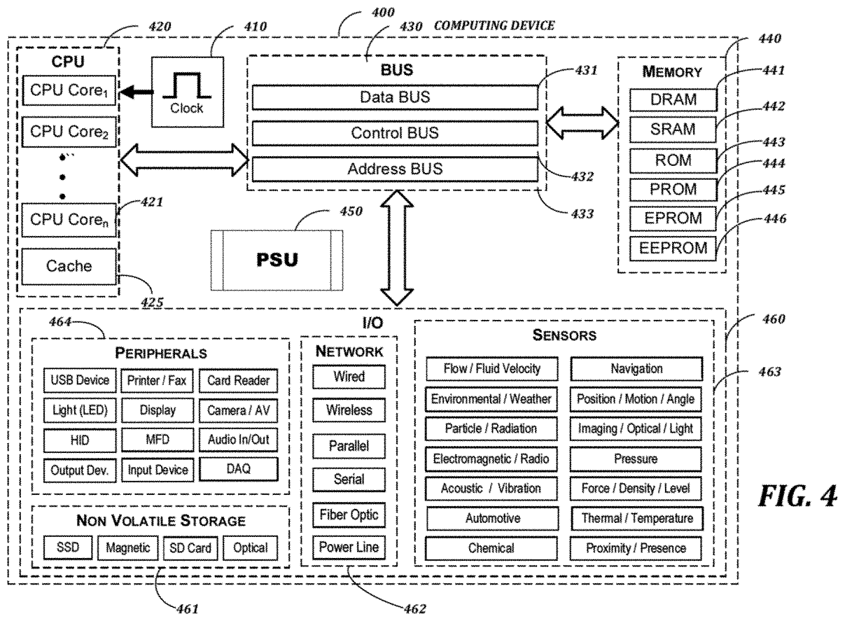

FIG. 4 is a block diagram of a system including computing device 400. Consistent with an embodiment of the disclosure, the aforementioned CPU 420, the bus 430, the memory unit 0, a PSU 450, and the plurality of I/O units 460 may be implemented in a computing device, such as computing device 400 of FIG. 4. Any suitable combination of hardware, software, or firmware may be used to implement the aforementioned units. For example, the CPU 420, the bus 430, and the memory unit 0 may be implemented with computing device 400 or any of other computing devices 400, in combination with computing device 400. The aforementioned system, device, and components are examples and other systems, devices, and components may comprise the aforementioned CPU 420, the bus 430, the memory unit 0, consistent with embodiments of the disclosure.

With reference to FIG. 4, an edge device consistent with an embodiment of the disclosure may include a computing device, such as computing device 400. In a basic configuration, computing device 400 may include at least one clock module 410, at least one CPU 420, at least one bus 430, and at least one memory unit 0, at least one PSU 450, and at least one I/O 460 module, wherein I/O module may be comprised of, but not limited to a non-volatile storage sub-module 461, a communication sub-module 462, a sensors sub-module 463, and a peripherals sub-module 464.

A system consistent with an embodiment of the disclosure the computing device 400 may include the clock module 410 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 420, the central component of modern computers, which relies on a clock. The only exceptions are asynchronous circuits such as asynchronous CPUs. The clock 410 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 4 wires.

Many computing devices 400 use a “clock multiplier” which multiplies a lower frequency external clock to the appropriate clock rate of the CPU 420. This allows the CPU 420 to operate at a much higher frequency than the rest of the computer, which affords performance gains in situations where the CPU 420 does not need to wait on an external factor (like memory 0 or input/output 460). Some embodiments of the clock 410 may include dynamic frequency change, where the time between clock edges can vary widely from one edge to the next and back again.

A system consistent with an embodiment of the disclosure the computing device 400 may include the CPU unit 420 comprising at least one CPU Core 421. A plurality of CPU cores 421 may comprise identical CPU cores 421, such as, but not limited to, homogeneous multi-core systems. It is also possible for the plurality of CPU cores 421 to comprise different CPU cores 421, such as, but not limited to, heterogeneous multi-core systems, big.LITTLE systems and some AMD accelerated processing units (APU). The CPU unit 420 reads and executes program instructions which may be used across many application domains, for example, but not limited to, general purpose computing, embedded computing, network computing, digital signal processing (DSP), and graphics processing (GPU). The CPU unit 420 may run multiple instructions on separate CPU cores 421 at the same time. The CPU unit 420 may be integrated into at least one of a single integrated circuit die and multiple dies in a single chip package. The single integrated circuit die and multiple dies in a single chip package may contain a plurality of other aspects of the computing device 400, for example, but not limited to, the clock 410, the CPU 420, the bus 430, the memory 0, and I/O 460.

The CPU unit 420 may contain cache 422 such as, but not limited to, a level 1 cache, level 2 cache, level 3 cache, or combination thereof. The aforementioned cache 422 may or may not be shared amongst a plurality of CPU cores 421. The cache 422 sharing comprises at least one of message passing and inter-core communication methods may be used for the at least one CPU Core 421 to communicate with the cache 422. The inter-core communication methods may comprise, but not limited to, bus, ring, two-dimensional mesh, and crossbar. The aforementioned CPU unit 420 may employ symmetric multiprocessing (SMP) design.

The plurality of the aforementioned CPU cores 421 may comprise soft microprocessor cores on a single field programmable gate array (FPGA), such as semiconductor intellectual property cores (IP Core). The plurality of CPU cores 421 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 421, for example, but not limited to Instruction-level parallelism (ILP) such as, but not limited to, superscalar pipelining, and Thread-level parallelism (TLP).

Consistent with the embodiments of the present disclosure, the aforementioned computing device 400 may employ a communication system that transfers data between components inside the aforementioned computing device 400, and/or the plurality of computing devices 400. The aforementioned communication system will be known to a person having ordinary skill in the art as a bus 430. The bus 430 may embody internal and/or external plurality of hardware and software components, for example, but not limited to a wire, optical fiber, communication protocols, and any physical arrangement that provides the same logical function as a parallel electrical bus. The bus 430 may comprise at least one of, but not limited to a parallel bus, wherein the parallel bus carry data words in parallel on multiple wires, and a serial bus, wherein the serial bus carry data in bit-serial form. The bus 430 may embody a plurality of topologies, for example, but not limited to, a multidrop/electrical parallel topology, a daisy chain topology, and a connected by switched hubs, such as USB bus. The bus 430 may comprise a plurality of embodiments, for example, but not limited to:
Internal data bus (data bus) 431/Memory bus
Control bus 432
Address bus 433
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as, but not limited to, Accelerated Graphics Port (AGP), Peripheral Component Interconnect eXtended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and eXtensible Host Controller Interface (xHCI).

Consistent with the embodiments of the present disclosure, the aforementioned computing device 400 may employ hardware integrated circuits that store information for immediate use in the computing device 400, know to the person having ordinary skill in the art as primary storage or memory 0. The memory 0 operates at high speed, distinguishing it from the non-volatile storage sub-module 461, which may be referred to as secondary or tertiary storage, which provides slow-to-access information but offers higher capacities at lower cost. The contents contained in memory 0, may be transferred to secondary storage via techniques such as, but not limited to, virtual memory and swap. The memory 0 may be associated with addressable semiconductor memory, such as integrated circuits consisting of silicon-based transistors, used for example as primary storage but also other purposes in the computing device 400. The memory 0 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 1, Static Random-Access Memory (SRAM) 2, CPU Cache memory 425, Advanced Random-Access Memory (A-RAM), and other types of primary storage such as Random-Access Memory (RAM).
Non-volatile memory which can retain stored information even after power is removed, for example, but not limited to, Read-Only Memory (ROM) 3, Programmable ROM (PROM) 4, Erasable PROM (EPROM) 5, Electrically Erasable PROM (EEPROM) 6 (e.g., flash memory and Electrically Alterable PROM [EAPROM]), Mask ROM (MROM), One Time Programable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).

Consistent with the embodiments of the present disclosure, the aforementioned computing device 400 may employ the communication system between an information processing system, such as the computing device 400, and the outside world, for example, but not limited to, human, environment, and another computing device 400. The aforementioned communication system will be known to a person having ordinary skill in the art as I/O 460. The I/O module 460 regulates a plurality of inputs and outputs with regard to the computing device 400, wherein the inputs are a plurality of signals and data received by the computing device 400, and the outputs are the plurality of signals and data sent from the computing device 400. The I/O module 460 interfaces a plurality of hardware, such as, but not limited to, non-volatile storage 461, communication devices 462, sensors 463, and peripherals 464. The plurality of hardware is used by the at least one of, but not limited to, human, environment, and another computing device 400 to communicate with the present computing device 400. The I/O module 460 may comprise a plurality of forms, for example, but not limited to channel I/O, port mapped I/O, asynchronous I/O, and Direct Memory Access (DMA).

Consistent with the embodiments of the present disclosure, the aforementioned computing device 400 may employ the non-volatile storage sub-module 461, which may be referred to by a person having ordinary skill in the art as one of secondary storage, external memory, tertiary storage, off-line storage, and auxiliary storage. The non-volatile storage sub-module 461 may not be accessed directly by the CPU 420 without using intermediate area in the memory 0. The non-volatile storage sub-module 461 does not lose data when power is removed and may be two orders of magnitude less costly than storage used in memory module, at the expense of speed and latency. The non-volatile storage sub-module 461 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (461) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the aforementioned computing device 400 may employ the communication sub-module 462 as a subset of the I/O 460, which may be referred to by a person having ordinary skill in the art as at least one of, but not limited to, computer network, data network, and network. The network allows computing devices 400 to exchange data using connections, which may be known to a person having ordinary skill in the art as data links, between network nodes. The nodes comprise network computer devices 400 that originate, route, and terminate data. The nodes are identified by network addresses and can include a plurality of hosts consistent with the embodiments of a computing device 400. The aforementioned embodiments include, but not limited to personal computers, phones, servers, drones, and networking devices such as, but not limited to, hubs, switches, routers, modems, and firewalls.

Two nodes can be said are networked together, when one computing device 400 is able to exchange information with the other computing device 400, whether or not they have a direct connection with each other. The communication sub-module 462 supports a plurality of applications and services, such as, but not limited to World Wide Web (WWW), digital video and audio, shared use of application and storage computing devices 400, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]).

The communication sub-module 462 may comprise a plurality of size, topology, traffic control mechanism and organizational intent. The communication sub-module 462 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G, 4G (such as WiMax and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 400 may employ the sensors sub-module 463 as a subset of the I/O 460. The sensors sub-module 463 comprises at least one of the devices, modules, and subsystems whose purpose is to detect events or changes in its environment and send the information to the computing device 400. Sensors are sensitive to the measured property, are not sensitive to any property not measured, but may be encountered in its application, and do not significantly influence the measured property. The sensors sub-module 463 may comprise a plurality of digital devices and analog devices, wherein if an analog device is used, an Analog to Digital (A-to-D) converter must be employed to interface the said device with the computing device 400. The sensors may be subject to a plurality of deviations that limit sensor accuracy. The sensors sub-module 463 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensor (guitar pickup), seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 400 may employ the peripherals sub-module 462 as a subset of the I/O 460. The peripheral sub-module 464 comprises ancillary devices uses to put information into and get information out of the computing device 400. There are 3 categories of devices comprising the peripheral sub-module 464, which exist based on their relationship with the computing device 400, input devices, output devices, and input/output devices. Input devices send at least one of data and instructions to the computing device 400. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to position of a mouse.
The number of degrees of freedom involved, such as, but not limited to, two-dimensional mice vs three-dimensional mice used for Computer-Aided Design (CAD) applications.

Output devices provide output from the computing device 400. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 464:
Input Devices
   Human Interface Devices (HID), such as, but not limited to, pointing device (e.g., mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 400. The information can be stored in a multitude of formats depending on the user's requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device, in order to capture produced sound. Audio input devices allow a user to send audio signals to the computing device 400 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices convert at least one of analog signals and physical parameters to digital values for processing by the computing device 400. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers and plotters.
   Audio and Video (AV) devices, such as, but not limited to, speakers, headphones, amplifiers, and lights, which include lamps, strobes, DJ lighting, stage lighting, architectural lighting, special effect lighting, and lasers.
   Light Emitting Devices such as third-party lamps and luminaires
   Other devices such as Digital to Analog Converter (DAC)
Input/Output Devices may further comprise, but not be limited to, touchscreens, networking device (e.g., devices disclosed in network 462 sub-module), data storage device (non-volatile storage 461), facsimile (FAX), and graphics/sound cards.

All rights including copyrights in the code included herein are vested in and the property of the Applicant. The Applicant retains and reserves all rights in the code included herein, and grants permission to reproduce the material only in connection with reproduction of the granted patent and for no other purpose.

### IV. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A light emitting device comprising:
a lamp for emitting light having a wavelength of greater than 590 nm;
a controller in operative connection with the lamp for receiving touch commands from a user, the controller causing the lamp to illuminate based on the received touch controls; and
a housing surrounding the lamp and the controller, the housing comprising a capacitive touchpad configured to dampen sound from a user activation of the touchpad.

2. The light emitting device of claim 1, the housing comprising a light diffuser formed from wood.

3. The light emitting device of claim 2, wherein the light diffuser enclosure is configured to prevent light having a wavelength within a range of about 480-490 nm from passing through the diffuser.

4. The light emitting device of claim 2, wherein the light diffuser is configured to permit light having a wavelength of greater than 620 nm to pass through the diffuser.

5. The light emitting device of claim 2, wherein the light diffuser comprises one or more optical coatings.

6. The light emitting device of claim 2, further comprising a piezoelectric audio amplifier, wherein the piezoelectric audio amplifier is connected to the diffuser such that the diffuser acts as a speaker membrane.

7. The light emitting device of claim 1, wherein the housing comprises one or more reflectors disposed on an interior surface of the housing, the one or more reflectors configured to enhance blue light absorption and promote red light reflectance.

8. The light emitting device of claim 7, wherein the one or more reflectors are configured to absorb light having a wavelength of less than about 580 nm.

9. The light emitting device of claim 7, wherein the one or more reflectors are configured to reflect light having a wavelength greater than 620 nm.

10. The light emitting device of claim 1, wherein the capacitive touchpad comprises:
an inner dielectric layer;
an outer dielectric layer; and
a conductive layer disposed between the inner dielectric layer and the outer dielectric layer,
wherein the outer dielectric layer has a thickness sufficient to allow for capacitive coupling between a human user and the conductive layer.

11. The light emitting device of claim 10, wherein the outer dielectric layer is formed from wood.

12. The light emitting device of claim 1, wherein the controller comprises a dimming device to adjust a brightness of the lamp.

13. The light emitting device of claim 1, further comprising one or more rubberized feet configured to damp sound from movement of the device.

14. The light emitting device of claim 1, wherein the lamp only emits light having a wavelength of greater than 590 nm.

15. A light emitting device comprising:
a lamp for emitting light;
a controller in operative connection with the lamp for receiving touch commands from a user, the controller causing the lamp to illuminate based on the received touch controls;
an optical member at least partially surrounding the lamp, the optical member being configured to allow light from the lamp having a wavelength of greater than 590 nm to pass through the optical member, and to prevent light having a wavelength of less than 590 nm to pass through the optical member; and
a housing surrounding the lamp and the controller, the housing comprising a capacitive touchpad configured to dampen sound from a user activation of the touchpad.

16. The light emitting device of claim 15, wherein the capacitive touchpad comprises:
an inner dielectric layer;
an outer dielectric layer; and
a conductive layer disposed between the inner dielectric layer and the outer dielectric layer,
wherein the outer dielectric layer has a thickness sufficient to allow for capacitive coupling between a human user and the conductive layer.

17. The light emitting device of claim 16, wherein the outer dielectric layer is formed from wood.

18. The light emitting device of claim 15, further comprising one or more rubberized feet configured to dampen sound from movement of the device.

19. The light emitting device of claim 15, wherein the optical member is configured to:
prevent light having a wavelength less than 620 nm from passing through the optical membrane, and
permit light having a wavelength greater than 620 nm to pass through the optical member.

20. The light emitting device of claim 2, further comprising a piezoelectric audio amplifier, wherein the piezoelectric audio amplifier is connected to the diffuser such that the diffuser acts as a speaker membrane.
